(19) United States
(12) Patent Application Publication
(10) Pub. No.: US 2020/0026174 A1
(43) Pub. Date: Jan. 23, 2020

(54) PROJECTION DEVICE

(71) Applicant: Gatebox Inc., Tokyo (JP)

(72) Inventor: Kenji Morita, Tokyo (JP)

(21) Appl. No.: 16/515,457

(22) Filed: Jul. 18, 2019

(30) Foreign Application Priority Data
Jul. 19, 2018 (JP) 2018-136267

(51) Int. Cl. G03B 21/28; H04N 13/363; H04N 13/388; H04N 9/31

(52) U.S. Cl. CPC G03B 21/28; H04N 9/31; H04N 13/388; H04N 13/363

(57) ABSTRACT

A projection device is configured to enable more suitable recognition of a display object. The projection device includes a projector configured to project light, a reflector configured to reflect light emitted from the projector, a screen, to which the light reflected by the reflector is projected, and through which at least some of the projected light transmits, and a housing in which the projector, the reflector and the screen are installed, wherein the reflector is inclined with respect to the screen and is installed in the housing.

### TECHNICAL FIELD

This disclosure relates to a projection device.

### BACKGROUND

Japanese Unexamined Patent Application Publication No. 2001-197524 discloses a 3-dimensional image display device in which an opaque screen that is rapidly rotated in a transparent windshield is provided, and a display object is 3-dimensionally displayed. However, in JP '524, the display object may not be suitably displayed to a user.

### SUMMARY

We provide a projection device including a projector configured to project light, a reflector configured to reflect light emitted from the projector, a screen to which the light reflected by the reflector is projected, and which transmits at least some of the projected light, and a housing in which the projector, the reflector and the screen are installed, wherein the reflector is inclined with respect to the screen and is installed in the housing.

### BRIEF DESCRIPTION OF THE DRAWINGS

FIG. 1 is a schematic view showing a comparison of a positional relation of a projector and a mirror of a projection device according to an example.

FIG. 2 is a perspective view showing a projection device according to an example from above.

FIG. 3 is a perspective view showing a projection device according to an example from below.

FIGS. 4A and 4B each are an optical path diagram of a projection image in the projection device according to an example, FIG. 4A is a view showing an aspect when a mirror that is inclined with respect to a screen is provided, and FIG. 4B is a view showing an aspect when a mirror that is parallel to the screen is provided.

FIG. 5 is a schematic view showing a positional relation between the mirror and the screen of the projection device according to an example.

FIG. 6 is a perspective view of the projection device according to an example when seen from below a front surface thereof.

FIG. 7 is a schematic view showing an attachment of the mirror of the projection device according to an example.

FIGS. 8A to 8C each are a view schematically showing an instrument mounted on the projection device according to an example, FIG. 8A shows an instrument installed in an upper accommodating section, FIG. 8B shows an instrument installed on a column section, and FIG. 8C shows an instrument installed in a lower accommodating section.

FIG. 9 is a functional block diagram of the projection device according to an example.

FIG. 10 is a graph comparing diffusiblity of a scattering member using the screen of the projection device according to an example and luminance of light in the screen.

FIG. 11A to 11C each are a schematic view showing a comparison of diffusiblity of the scattering member and luminance of light in the screen in the projection device according to an example, FIG. 11A shows luminance in the screen when diffusiblity is weak, FIG. 11B shows luminance in the screen when diffusiblity is strong, and FIG. 11C shows luminance in the screen when the diffusiblity is weak but the luminance of the light that is radiated is high.

### EXPLANATION OF REFERENCES

1 Projection device
2 Housing
2a First window member
2b Second window member
21 Upper accommodating section
22 Lower accommodating section
221 Pedestal
23 Column
3 Screen
4 Projector (projection unit)
5 Mirror (reflection unit)
51 Attachment section
6 Column section
71 Controller (projection unit)
72 Input device
73 Output device

### DETAILED DESCRIPTION

An example implementing a projection device according to this disclosure will be described with reference to the accompanying drawings.

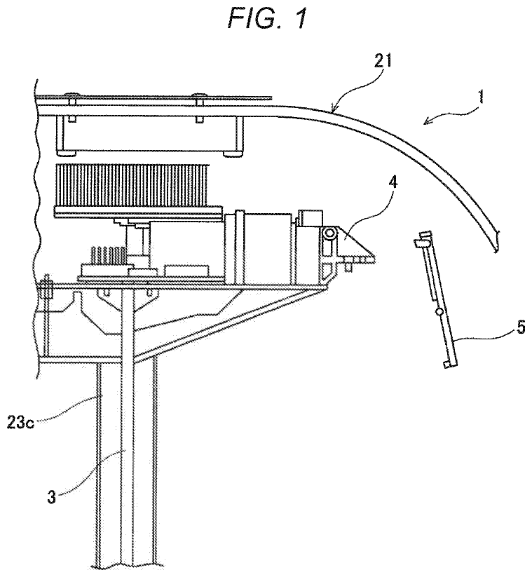

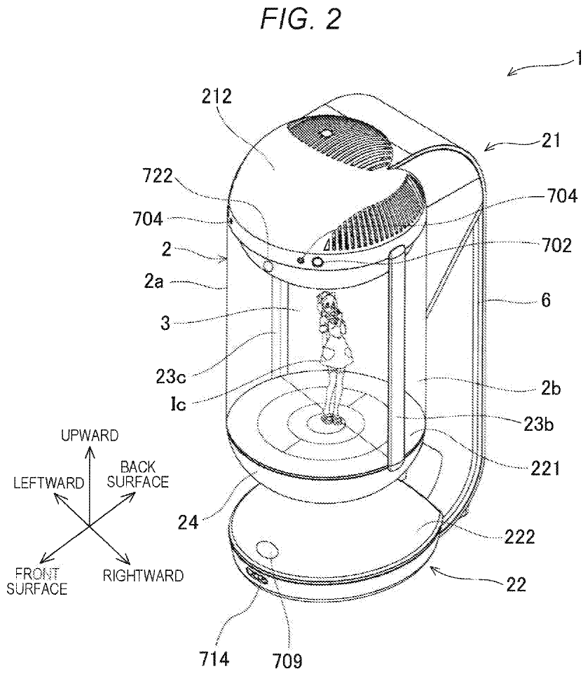

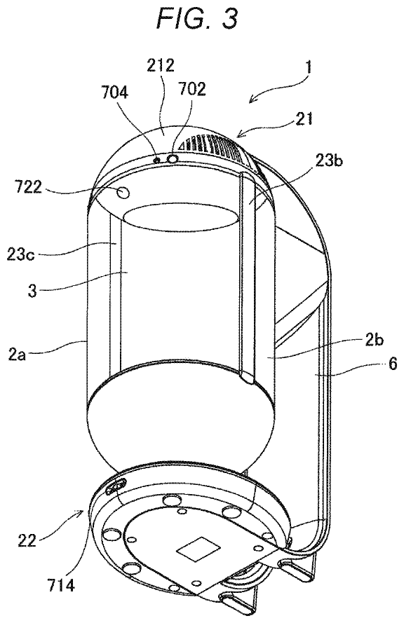

As shown in FIG. 1, a projection device 1 according to an example includes a projector 4 configured to project light, a mirror 5 (not limiting, an example of a reflector) configured to reflect the light emitted from the projector 4, and a screen 3 to which the light reflected by the mirror 5 is projected. As shown in FIG. 1, the mirror 5 is installed to be inclined with respect to the screen 3. In addition, the screen 3 has a property of transmitting at least some of the projected light. Accordingly, for example, as shown in FIG. 2, an image Ic of a character or a person (hereinafter referred to as a character or the like) projected by the projector 4 is reflected to the screen 3. For example, a user can see the image Ic projected forward from the projection device 1 to the screen 3. These optical system configuration members such as the projector 4, the mirror 5 and the screen 3 are installed in a housing 2, in which a cavity shown in FIG. 2 and FIG. 3 has a cylindrical shape, and at least a part of which has transmittance such as transparency or the like. In this way, when the mirror 5 is installed to be inclined with respect to the screen 3, the projector can be disposed substantially perpendicular to the screen and can contribute to a decrease in size of the entire device.

### Inclination of Mirror

As shown in FIG. 1, when the mirror 5 is installed to be inclined with respect to the screen 3, an optical path from the projector 4 to the screen 3 can be reduced compared to when the mirror 5 is installed parallel to the screen 3 or when an optical path from the projector 4 to the screen 3 is linear. In addition, when the mirror 5 is installed to be inclined with respect to the screen 3, a projection range from the mirror 5 can be expanded and the size of the mirror 5 can also be reduced compared to when the screen 3 and the mirror 5 are parallel to each other. Further, when an optical path distance from the projector 4 to the screen 3 is reduced, luminance in the screen 3 can be improved compared to when the optical path distance is short.

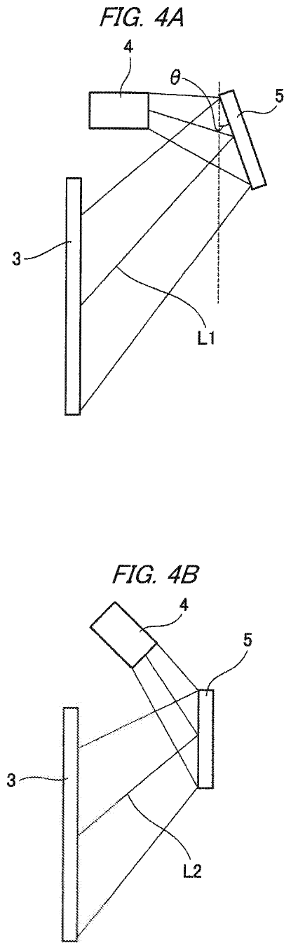

Specifically, as shown in FIG. 4A, a projection direction of light projected from the projector 4 is a direction perpendicular to the screen 3. Provisionally, when the mirror 5 is disposed parallel to the screen 3, the light from the mirror 5 returns to the projector 4 and the image is not projected to the screen 3. Accordingly, the mirror 5 is disposed to form an inclination of an angle θ with respect to the screen 3. For example, the mirror 5 can be disposed at an angle of 5 to 20° with respect to the screen 3 and, preferably, can be disposed to be inclined at 7 to 15° (in addition, preferably, may be disposed at θ=11°. Further, an inclination of the screen 3 is determined according to specifications or the like of the projector 4, the mirror 5 and the screen 3. Further, light from the projector 4 does not have to be exactly perpendicular to the screen 3, and may be projected substantially vertically or may be disposed to be inclined at an angle of 1 to 10°.

Provisionally, as shown in FIG. 4B, even though the mirror 5 is substantially parallel to the screen 3, when light from the projector 4 is projected to be inclined with respect to the mirror 5, an image can be projected to the screen 3. However, as shown in FIG. 4B, an optical path L2 required at this time is lengthened compared to optical path L1 in FIG. 4A.

That is, the configuration in which light from the projector 4 is perpendicular to the screen 3 and the mirror 5 is inclined with respect to the screen 3 as shown in FIG. 4A can reduce the size of an optical system configuration section compared to the configuration in which light from the projector 4 is projected to be inclined with respect to the mirror 5 as shown in FIG. 4B. Accordingly, when the optical system configuration section has the configuration of FIG. 4A rather than the configuration of FIG. 4B, the projection device 1 itself can also be reduced in size. When the optical system configuration section has the configuration of FIG. 4A rather than the configuration of FIG. 4B, the mirror 5 itself can also be reduced in size.

In addition, since the optical path L1<the optical path L2, provisionally, when the luminance of the light output from the projector 4 is identical, brightness of the image projected to the screen 3 is brighter in the configuration of FIG. 4A than in the configuration of FIG. 4B. Accordingly, in the configuration of FIG. 4A, compared to the configuration of FIG. 4B, even when a property of diffusiblity of the scattering member used in the screen 3 is weak, a high resolution image can be projected. For example, in the configuration of FIG. 4A, even in the scattering member having weak diffusiblity, luminance of the projected light is improved compared to the configuration of FIG. 4B. Accordingly, in the configuration shown in FIG. 4A, the lumenance in the screen 3 is secured, and a high resolution image can be projected. Further, specific components or the like of the scattering member will be described below. Further, in the example shown in FIG. 4A, when an upper side and a lower side of the image projected to the screen 3, i.e., an upper end side and a lower end side of the screen 3, are compared, since the upper side has a short optical path from the projector 4 and the lower side has a long optical path from the projector 4, the luminance of the upper side is stronger than the luminance of the lower side.

### Types of Reflector/Mirror

Various types of reflectors/mirrors that can reflect picture light from the projector 4 can be used as the mirror 5. Specifically, the mirror is a surface mirror or the like. In addition, while the mirror will be described below in detail, instead of the surface mirror, a multi-layered film mirror, a partial reflecting mirror, a half mirror or the like may be used as the mirror 5.

The surface mirror is a reflecting mirror in which mirror surface processing is performed on a surface of glass that is also called a surface reflecting mirror. In the surface mirror, a difference in a reflection coefficient of light due to an angle of incidence on the mirror is not large. Accordingly, adjustment of the mirror 5 is facilitated.

### Configuration of Projection Device

In the projection device 1 according to the example, as described above in detail using FIGS. 1 and 2, the projector 4, the mirror 5 and the screen 3 are provided in the cylindrical housing 2, and in addition, an upper accommodating section 21, a lower accommodating section 22 and a column section 6 are provided on an upper side, a lower side and a back surface side of the housing 2.

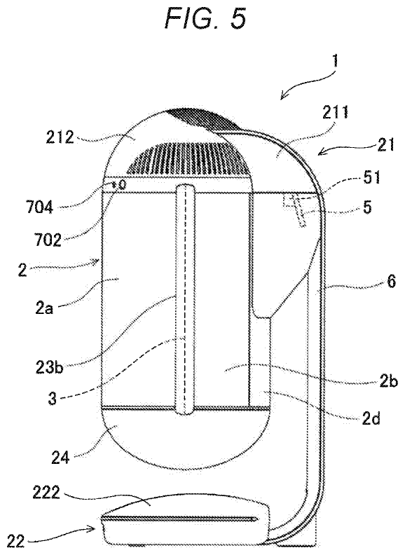

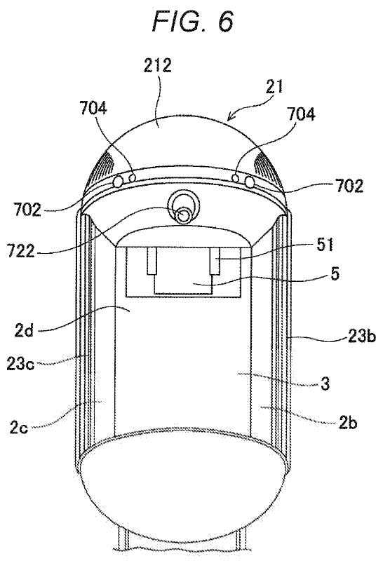

As shown in FIGS. 5 and 6, in the housing 2, a cylindrical space is formed by a first window member 2a, which is transparent, having a semi-columnar shape, a second window member 2b and a third window member 2c that are transparent and curved in a long axis direction, and a back surface cover section 2d, which is non-transmissive. In the housing 2, one end of the first window member 2a and one end of the second window member 2b are supported by a first column 23b, and the other end of the first window member 2a and one end of the third window member 2c are supported by a second column 23c. Further, the other ends of the second window member 2b and the third window member 2c are supported by the back surface cover section 2d. Further, while the window members 2a to 2c can be formed of a material such as acryl or glass, the material is not limited thereto and may be a material having transmittance.

As shown in FIG. 6, an upper section of the housing 2 on a back surface side, specifically, an upper section of the back surface cover section 2d has an opening, and light from the mirror 5 can directly reach the screen 3.

When the housing 2 has a cylindrical shape, in a picture projected to the screen 3 can be appropriately seen even from the front, right and left angles. In addition, when the back surface cover section 2d having non-transmittance is provided, it is possible to prevent indoor illumination or the like from entering the screen 3, and a picture displayed on the screen 3 can be easily seen.

Further, the columns 23b and 23c may be formed of a transparent member, and in this example, substantially the entire housing 2 can be formed to be transparent. However, the columns 23 may be opaque or translucent.

While not shown, light shielding processing such as application of light shielding paints or the like may be performed or may not be performed on circular sections of top and bottom surfaces of the housing 2. Accordingly, it is possible to prevent indoor illumination or the like from entering the screen 3, and a picture displayed on the screen 3 can be easily seen.

In addition, the housing 2 may include different window members or accessories other than the first window member on a part of a back surface or the like that do not have transmittance and may have gloss on top surfaces. Accordingly, when there is a larger amount of glare, it is more difficult to recognize glare on the screen 3. Further, an effect of enabling a display object to appear natural to a user is exhibited. The different first window members or accessory members may be a resin, an elastomer, a metal, glass, or those to which paints are applied. Accordingly, productivity, durability, functionality, designability or the like is improved.

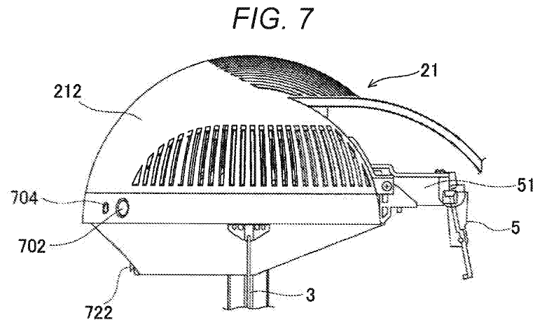

The mirror 5 is attached by, specifically, an attachment section 51 shown in FIG. 7 while being adjusted at an appropriate angle or orientation. The mirror 5 reflects a picture image from the projector 4, and the picture is projected to the screen 3 by the reflected light.

The screen 3 has a rectangular shape, and stands up to be substantially vertically provided in the vicinity of a center in the housing 2.

Specifically, as shown in FIG. 6, the screen 3 is supported by the two columns 23b and 23c that stand up at both ends of a pedestal 221, and thus the screen 3 stands up vertically at a center of the pedestal 221 while a top surface thereof is oriented toward a front surface side (a back surface side).

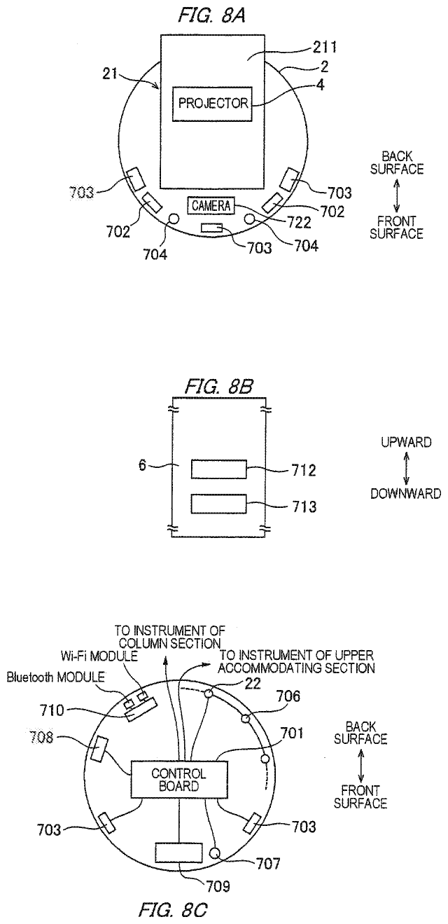

The lower accommodating section 22 is a box body formed of plastic or the like, and has a space in which a control board configured to perform various control operations including output control of the projector 4 and other instruments are attached. The control board or the like accommodated in the lower accommodating section 22 will be described below using FIG. 8C.

As shown in FIG. 5, a detachable lower cover 222 is provided on the lower accommodating section 22. The inside can be hidden by attaching the lower cover 222, and maintenance or the like of the instruments therein can be performed by removing the lower cover 222. In addition, the lower cover 222 may be formed of, for example, a mesh-shaped member.

As shown in FIG. 2, the screen 3 or the first window member 2a, the second window member 2b and the third window member 2c are supported by the columns 23 and the back surface cover section 2d and integrally stand up on the pedestal 221.

Accordingly, as shown in FIG. 2, the first window member 2a, the second window member 2b and the third window member 2c stand up on the pedestal 221 in a circular shape together with the back surface cover section 2d, and the screen 3 is provided such that, for example, a lower section (a lower end) is disposed along an upper surface (a top surface) of the pedestal 221 while the inside is inscribed in the housing 2.

As shown in FIG. 2, the pedestal 221 also functions as a stand on which a character or the like displayed in the housing 2 is virtually placed. That is, the pedestal 221 can be shown as a base substrate of a display case configured to accommodate a doll or a model to be displayable.

In the example, when an angle or an orientation of the mirror 5 is adjusted by the attachment section 51 shown in FIG. 7, a character's feet or the like are displayed to coincide with a lower end of the screen 3.

As a result, it can appear as if the character or the like were actually standing on the pedestal 221. A projection range of the projector 4 may overlap the pedestal.

In addition, as shown in FIG. 5, an accommodating section 24 under the pedestal is provided under the pedestal 221 and, for example, instruments such as a temperature/humidity sensor, a speaker and the like can be attached to the accommodating section 24 under the pedestal. The speaker outputs sound information such as sound, music or the like via an amplifier.

The upper accommodating section 21 has a space in which instruments such as the projector 4 and so on configured to output a picture are attached. The instruments accommodated in the upper accommodating section 21 will be described using FIG. 8A.

Specifically, as shown in FIG. 5, the upper accommodating section 21 includes an upper instrument attachment section 211 connected to an upper section of the column section 6. The projector 4 is attached to a lower surface of the upper instrument attachment section 211.

As shown in FIG. 5, a detachable upper cover 212 is provided on the upper accommodating section 21. The instruments such as the upper instrument attachment section 211, the projector 4 and the like can be hidden by attaching the upper cover 212, and maintenance or the like of the instruments therein can be performed by removing the upper cover 212.

Next, the instruments mounted on the projection device of the example will be described with reference to FIGS. 8A to 8C.

FIG. 8A is a schematic view of an instrument installed in the upper accommodating section, FIG. 8B is a schematic view of an instrument installed on the column section, and FIG. 8C is a schematic view of an instrument installed in the lower accommodating section.

### Instrument Installed in Upper Accommodating Section

As shown in FIG. 8A, the projector 4, a motion sensor 702, an infrared LED 703, a microphone 704 and a camera 722 are provided in the upper accommodating section 21.

As described above, the projector 4 projects a picture to the screen 3 via the mirror 5. The picture output from the projector 4 is, for example, a 2-D picture or a 3-D picture of a character that appears in any of various cartoons or animations, an actual person, an article or the like.

The motion sensors 702 (detectors) are sensors configured to detect a variation of infrared light to detect a location of a person, and provided at left and right sides of a front surface side.

The infrared LEDs 703 are provided at left and right sides and like those provided in the upper accommodating section 21, function as an infrared remote controller.

The microphones 704 (detectors) are provided at left and right sides, and receive sound emitted from a user.

The motion sensors 702 and the microphones 704 that are the detectors configured to detect surroundings of the housing may be installed outside the housing 2 or may not be installed. This is because a detection rate is degraded due to the presence of the first window member 2a when the motion sensors 702 and the microphones 704 are provided in the housing 2. In addition, since sound can be more easily detected by the microphone 704 disposed at the upper accommodating section 21 than the microphone 704 disposed at the lower accommodating section 22, the microphone 704 is preferably disposed at the upper accommodating section 21.

The camera (an imaging device) 722 is provided on the front side, and is an imaging means that images a still picture or a moving picture. The camera 722 is disposed in the housing 2. In addition, as shown in FIG. 7, the camera 722 is disposed at a position closer to the screen 3 than the motion sensor 702 or the microphone 704 that is the detector.

This is because accuracy of image recognition using the image captured by the camera 722 is improved. For example, when the image of the user captured by camera 722 is used in image recognition, when positions of the camera and the user are close to each other, image recognition becomes difficult. When a user sees the housing 2, the user tends to approach the housing 2 to get closer to the character. Accordingly, the camera 722 is disposed inside the housing 2 to move a position of the camera 722 from the user as far as possible and widen a face recognition range. That is, in the example shown in FIG. 7, accuracy of image recognition can be improved by disposing the camera 722 at a position close to the screen 3 in a depth direction.

In addition, the camera 722 is disposed between the projector 4 and an upper end of the screen 3 in an upward/downward direction. Specifically, the camera 722 is disposed below the projector 4 shown in FIG. 1 and above the upper end of the screen 3 as seen by the user shown in FIG. 2. The reason for this is that accuracy of image recognition can be improved by disposing the camera 722 at a position close to the character because the user sees the character displayed on the screen 3.

### Instrument Installed on Column Section

As shown in FIG. 8B, in addition to the above-mentioned mirror 5, a vibration sensor 712 and a noise sensor 713 are provided on the column section 6.

The vibration sensor 712 is a sensor configured to detect vibration and, for example, corresponds to a piezo vibration sensor. As the vibration detected by the vibration sensor 712, there is relatively small vibration by which a footstep or opening and shutting of a door can be identified, as well as a large shaking like an earthquake.

The noise sensor 713 is a sensor configured to detect indoor environmental sounds. As the environmental sounds detected by the noise sensor 713, for example, there is daily life noise (including sounds of a television) of a user, environmental sounds of a nearby place, or unwanted noise determined on the basis of a predetermined reference volume.

### Instrument Installed on Lower Accommodating Section

As shown in FIG. 8C, in addition to a control board 701, the infrared LED 703, a production LED 706, an infrared light receiving section 707, a status LED 708, a starting button 709 and a USB hub 710, a Wi-Fi (registered trademark) module, a Bluetooth (registered trademark) module or the like is installed in the lower accommodating section 22.

The control board 701 has one or a plurality of control chips on which a CPU, a ROM, a RAM, an HDMI (registered trademark) port, a LAN port, a USB port, and various input/output ports or the like, are mounted, and executes various output operations including that of a picture and sound on a predetermined instrument based on information received by various sensors or the like.

The infrared LEDs 703 are provided at left and right sides, and function as a receiver of a so-called infrared remote controller. Specifically, remote control of external instruments such as a television, a cleaner or the like can be performed by outputting infrared rays to the surroundings.

The production LED 706 is an emission means in the pedestal 221.

The infrared light receiving section 707 is provided on a front surface side, and receives infrared information related to remote control operations used in a remote controller of a television or lighting equipment from the remote controller.

The status LED 708 is a reporting means that shows a state of the projection device 1 (for example, power on, sleeping, error occurred, transmitting or the like), and identifiably informs a user of various states according to specified blinking patterns, luminescent colors or the like.

The starting button 709 is an operation means that performs ON/OFF of a power supply of a main body of the projection device 1.

The USB hub 710 is a hub configured to connect a plurality of USB instruments.

The Wi-Fi (registered trademark) module is a wireless LAN module connected to the USB hub that can provide an Internet environment to a wireless LAN adapter as an access point or can be connected to the Internet through another access point as the wireless LAN adapter.

The Bluetooth (registered trademark) module is a wireless communication interface that enables wireless communication with peripheral instruments such as a keyboard, a mouse or the like corresponding to a predetermined standard.

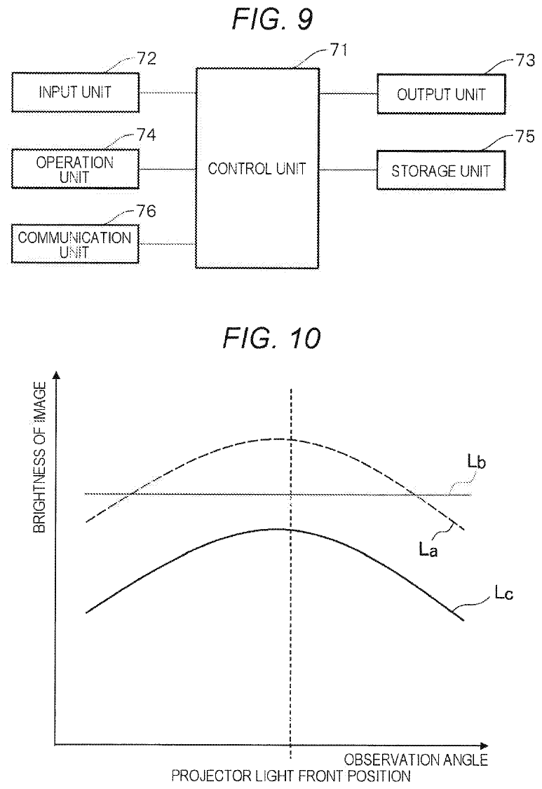

Next, functions realized by the above-mentioned instruments will be described with reference to FIG. 9.

FIG. 9 is a functional block diagram of the projection device 1 of the example.

As shown in FIG. 9, the projection device 1 of the example includes a controller 71, an input device 72, an output device 73, an operation device 74, a storage device 75, and a communication device 76.

The input device 72 is configured to receive input of various types of information detected by various sensors.

Data received by the input device 72 includes, for example, identification information output from the motion sensor 702 when the motion sensor 702 detects a person, sound information input via the microphone 704, information of an indoor temperature or humidity detected by a temperature/humidity sensor, information by which a size or a variation in vibration detected by the vibration sensor 712 can be identified, sound volume information input via the noise sensor 713, information of a still picture and a moving picture captured by the camera 722, illuminance information and so on.

The output device 73 is configured to perform output of a signal or information on the basis of a predetermined command.

The signal or information output from the output device 73 includes, for example, an infrared signal that controls operations of external instruments output from the infrared LED 703, sound information output via a speaker, light emitted from the production LED 706, a picture output from the projector 4 and the like.

The operation device 74 is a structure adapted for a user and, for example, corresponds to a keyboard or a mouse (not shown).

The operations performed by the operation device 74 include, for example, ON/OFF of a power supply of a device main body by the starting button 709 or the like.

The storage device 75 is a storage structure constituted of, for example, a RAM, a non-volatile memory such as an EEPROM, a flash memory or the like that constitutes the controller 71, and is configured to store a program or data that executes various functions provided in the projection device 1.

Data stored in the storage device 75 includes remote control information related to a remote controller of an external instrument such as a television, lighting equipment or the like, calendar information registered on a calendar site, attribute information of a user, attribute information of a device main body or instruments, information input from sensors, information of a picture or sound of a character or the like linked to identification information or the like of a character string or the like of a name of the character or the like, music information and the like.

The program stored in the storage device 75 is a sound recognition program, an artificial intelligence program or the like, in addition to a program that executes various control operations, which will be described.

The communication device 76 is a communication structure that performs bidirectional or one-way data communication processing between external instruments through wired or wireless communication.

For example, various types of data can be transmitted and received between the instruments connected to the Internet via wireless communication on the basis of a LAN cable connected to a LAN port or a Wi-Fi (registered trademark) module.

The data that can be received by the communication device 76 include, for example, weather information that can be transmitted from a weather information site, and information that can be acquired via the Internet such as calendar information registered on a calendar site or the like.

The controller 71 performs various control operations according to a predetermined program.

For example, the controller 71 can access the weather information site when a main body device is started, acquire weather information of the day and store the weather information in the storage device 75.

In addition, the controller 71 can periodically access the calendar site on which a user's schedule is registered, and store newest calendar information obtained thereby in the storage device 75.

In addition, the controller 71 can receive remote control information (infrared information) related to the external instrument from the remote controller of the external instrument such as a television or illumination or the like using the infrared light receiving section 707 to store (learn) the remote control information in the storage device 75, and transmit the infrared information for operating the external instrument from the infrared LED 703 on the basis of the remote control information.

In addition, the controller 71 controls output of information including a picture from the projector on the basis of the input information by being operated as a controller.

### Prevention of Glare

When a user looks at the housing 2 from a front surface, the user may see himself/herself in the mirror 5 disposed behind the character displayed on the screen 3. For example, the user approaches the projection device 1 to see the character closely. When the user looks into the housing 2 from the lower side of the projection device 1, the user can see the mirror 5. In addition, when the user can see the mirror 5, the user may appear in the mirror 5. In this way, the user appears in the mirror, the sense of reality is enhanced, and there is a risk of the realism of the character decreasing. In particular, like the configuration of the example, when the mirror 5 is disposed to be inclined with respect to the screen 3, the probability of the user being reflected in the mirror 5 and viewed by the user is further increased. In this way, to prevent the user from appearing in the mirror 5, it is preferable to adjust a type of the mirror 5 or a reflection coefficient of the mirror 5. For example, an angle of the mirror 5 may be adjusted so that the user is not reflected in the mirror 5, or a top surface of the mirror 5 may be adjusted so that the user cannot be seen.

Specifically, various mirrors that can reflect a picture image from the projector 4 can be used as the mirror 5. For example, a multi-layered film mirror, a partial reflecting mirror or a half mirror can be used as the mirror 5.

A multi-layered film mirror or a dielectric multi-layered film mirror is a reflecting mirror obtained by laminating a plurality of dielectric films having different refractive indices. In the multi-layered film mirror, a difference between reflection coefficients of light according to angles entering the mirror is large. In this example, an angle of light output from the projector 4 entering the mirror 5 can be adjusted and projection to the screen 3 can be adjusted by adjusting an inclination of the mirror 5. When the multi-layered film mirror is used, the reflection coefficient of the light entering from an angle inclined with respect to a reflecting surface of the mirror 5 by about 30 to 45 degrees from a vertical line may be higher or may not be higher than the reflection coefficient of the light entering perpendicular to the reflecting surface of the mirror 5. Accordingly, while the user is normally reflected in the mirror 5 when a user sees the screen 3, it can be made more difficult for the user to see himself/herself by adjusting the reflection coefficient of the multi-layered film mirror when the user sees the mirror from an angle that is nearly perpendicular to the mirror.

Next, when the partial reflecting mirror is used as the mirror 5 will be described. The partial reflecting mirror is a mirror having a property of reflecting only some of incidence light and transmitting some of the incidence light. The partial reflecting mirror is, for example, a mirror having a reflection coefficient of 60 to 90% or the like. The partial reflecting mirror includes a half mirror having a reflection coefficient of 50%. In this way, by reducing the reflection coefficient, while the user itself is reflected in the mirror 5 when the user sees the screen 3, since the reflection coefficient is decreased, the user cannot easily recognize itself.

Further, when the mirror 5 is a mirror in which a surface opposite to a light incidence surface from the projector 4 is seen like the partial reflecting mirror, it is preferable to perform processing of minimizing reflection of light to a surface opposite to a reflection surface of light emitted from the projector 4. That is, when the partial reflecting mirror is used, to prevent a user from seeing a back surface side of the partial reflecting mirror, it is preferable to perform processing for preventing light from transmitting a back surface of the partial reflecting mirror or the like. For example, a material having non-transmittance may be applied to a back side of the partial reflecting mirror, or a film or the like having non-transmittance may be adhered to a back side of the partial reflecting mirror.

In addition, the mirror 5 may have a configuration in which unevenness is provided on at least a part of the reflecting surface of the mirror 5. As a method of providing unevenness on the mirror 5, before depositing a reflecting surface of aluminum or the like on the mirror 5, unevenness is provided on a foundation of the mirror 5 through sandblasting or the like. The mirror 5 having unevenness (not limited, an example of second unevenness) on a part of the reflecting surface may be manufactured by depositing aluminum on the foundation of the mirror 5 to which the unevenness is provided, or may be manufactured through another method. Further, a particle diameter of the unevenness provided through sandblasting or the like may be or may not be about 1 micrometer to 1 millimeter. In addition, a region of the reflecting surface on which the unevenness is provided may be or may not be set to about 10 to 40% of the entire reflecting surface. The region may be or may not be set to about the same level as the reflection coefficient of the above-mentioned partial reflecting mirror. In addition, the region on which the unevenness is provided may be or may not be evenly provided on the entire reflecting surface. The region may have a configuration in which unevenness is provided only in the vicinity of a center of the reflecting surface or may have a configuration in which unevenness is provided on an end portion of the reflecting surface.

When such unevenness is fabricated on the mirror 5, some of the light emitted from the projector 4 is reflected by the reflecting surface having no unevenness and imaged on the screen 3. However, the other light is scattered by a concavo-convex surface and is not imaged on the screen. For this reason, brightness of the image imaged on the screen 3 is decreased, and resolution of the image is also decreased. However, when the user looks the housing 2 from a front surface, in the image of the user itself reflected in the mirror 5 disposed behind the character displayed on the screen 3, an image of the user itself reflected in the mirror 5 is distorted by the unevenness provided on the mirror 5, and an image of the user itself reflected in the mirror 5 cannot be easily seen. That is, an image of the user itself reflected in the mirror 5 cannot be easily recognized by thinning out some of the light imaged on the screen among the light emitted from the projector. In addition, in other words, an image of the user itself reflected in the mirror 5 cannot be easily recognized by reducing an area of the mirror 5 that is appropriately reflected. Further, the reflecting surface having no unevenness may not be a surface having no unevenness. The reflecting surface may have slight unevenness, and the unevenness (not limited, an example of the first unevenness) may be or may not be the unevenness smaller than the unevenness of the concavo-convex surface.

As described above, a user's own image reflected in the mirror 5 cannot be easily seen by the user by providing the unevenness on the part of the reflecting surface of the mirror 5. For this reason, an appropriate projection image can be displayed to the user.

In addition, the mirror can be simply manufactured at a low cost by depositing aluminum or the like that is the reflecting surface on the surface having unevenness.

Further, as a method of providing unevenness on the mirror 5, the unevenness is provided on the foundation of the mirror 5 through sandblasting or the like before depositing aluminum on the mirror 5. While the method of manufacturing the mirror 5 having unevenness on a part of the reflecting surface by depositing aluminum on the foundation of the mirror 5 on which unevenness is provided has been described, the mirror 5 may be manufactured as follows. That is, after depositing aluminum or the like on the mirror 5, unevenness may be or may not be provided on the mirror 5 through sandblasting or the like.

Further, since the user looks into the housing 2 via the first window member 2a of the housing 2, glare of the user to the mirror 5 can be minimized also due to existence of the first window member 2a. Glare of the user in the mirror 5 cannot be easily recognized by reflecting the user itself and a background of the user in the first window member 2a. This is because it is difficult for the user to recognize himself/herself reflected in the mirror 5 even when the user appears in the mirror 5.

### Elements of Screen

The screen 3 is a flat member having transmittance, and functions as a transparent screen to which a predetermined picture is projected. For example, the screen 3 may be formed of acryl, polycarbonate or the like, having high transparency.

In addition, the screen 3 preferably includes a scattering member configured to scatter the projected light. That is, since the screen 3 has transmittance, a viewing angle is narrowed. Projector light projected to the screen 3 can be scattered and a viewing angle can be increased to obtain the viewing angle sufficient to facilitate recognition to the user by including a scattering member in the screen 3, and when the user sees the projection device 1, an image of the character displayed on the screen 3 can be recognized from a wide range. The scattering member is a general diffusion material.

The scattering member is, for example, inorganic particles or the like, and more specifically, may be or may not be metal-based inorganic particles. In addition, when the metal-based inorganic particles are used, atomized particles of, metal oxides or materials other than the metal oxides, may be or may not be used. As the metal oxide, zirconium oxide, titanium oxide, zinc oxide, aluminum oxide, cerium oxide or the like, may be or may not be employed. In addition, as the materials other than the metal oxides, barium titanate, barium sulfate or the like, may be exemplified. In consideration of securing a scattering property, zirconium oxide, titanium oxide particles, cerium oxide particles, barium titanate and barium sulfate particles may be or may not be used.

Further, instead of the screen 3, a transparent plate member, a translucent plate member, a film member or the like, may be used. In addition, transparency of the screen 3 may be adjusted. For example, the screen 3 may use a plate member or the like formed of a material that is smoked with black. Accordingly, when a user recognizes the character on the projection device 1, presence of the screen 3 is lowered and realism of the character is improved. In addition, in the smoked screen 3, a contour of the image can be made clear by absorbing diffusion light in the screen 3.

### Diffusiblity of Scattering Member

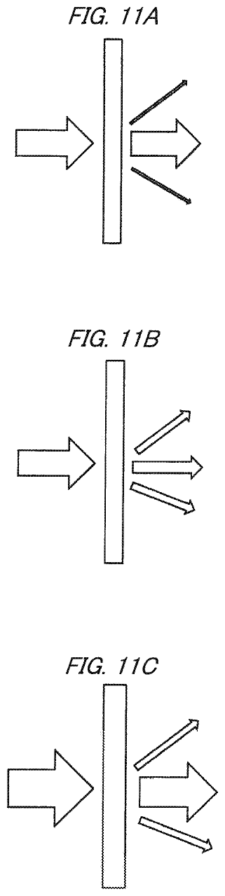

Next, the scattering member will be described. Sharpness of the image projected to the screen 3 differs according to properties of the scattering member. For example, as shown in FIGS. 10 and 11A, when light is projected to the screen 3 including the scattering member having weak diffusiblity, compared to a front position of the projector light, brightness of the image is decreased away from a front surface of the projector light (La in FIG. 10). That is, in the screen 3 including scattering member having weak diffusiblity as shown in FIG. 11A, a viewing angle is narrowed, and the image projected to the screen 3 cannot be easily recognized in a wide range.

Meanwhile, as shown in FIGS. 10 and 11B, when light is projected to the screen 3 including the scattering member having strong diffusiblity, the projector light is strong at the front position and also strong at positions other than the front position, and brightness of the image is substantially uniform and strong (Lb in FIG. 10). That is, in the screen 3 including the scattering member having strong diffusiblity as shown in FIG. 11B, since the light is strongly transmitted in a wide range, a viewing angle is widened and the image projected to the screen 3 can be recognized in a wide range. Accordingly, sharpness of the image can be improved using the strong scattering member. The scattering member having strong diffusiblity is, for example, diamond particles or the like.

On the other hand, as shown in FIGS. 10 and 11C, even if the scattering member having weak diffusiblity is used in the screen 3, when luminance of the projected light is strong, since brightness of the image is increased as a whole, sharpness of the image can be improved (Lc in FIG. 10). That is, when luminance of the projected light is high, even in the screen 3 including the scattering member having weak diffusiblity as shown in FIG. 11C, a range in which the image can be recognized by the user is widened, and the image projected to the screen 3 can be recognized in a wide range. The scattering member having weak diffusiblity is, for example, the above-mentioned inorganic particles or the like. Since the projection device 1 according to the example can improve the luminance by shortening an optical path from the projector 4 to the screen 3 as described using FIG. 4A, the scattering member included in the screen 3 may use or may not use a material having weak diffusiblity.

Further, while not shown in FIG. 10 and FIGS. 11A to 11C, when light having high luminance is projected to the screen 3 using the scattering member having strong diffusiblity, the light having high luminance is strongly diffused, and resolution becomes coarse. Accordingly, after adjusting the property of the scattering member and the luminance, it is preferable to select the scattering member and the luminance that optimize the picture projected to the screen 3.

### Projector

As described in detail using FIGS. 4A and 4B, in the image projected to the screen 3, the luminance tends to increase at a portion in which an optical path length of the projector light is small, and the luminance tends to decrease at a portion separated from the optical path length. Accordingly, to perform correction thereof, compared to the portion of the image projected by the projector 4 from a place in the image in which an optical path length is reduced, the projector 4 is controlled to strengthen the luminance of the portion projected from the place in which the optical path length is increased and correcting the image uniformized as a whole. The control is executed by, for example, the controller 71.

A type of the projector 4 is not limited, and various projectors such as a 3LCD type liquid crystal projector, a DLP projector, an LCOS type reflective liquid crystal projector and so on, may be applied. In the example, the light projected by the projectors 4 projects a picture on the screen (the screen 3) via the mirror 5.

Specifically, the projector 4 of the example is attached to the upper accommodating section 21 such that an output picture is directed toward the mirror 5 on an upper section of the column section 6 standing up away from a back surface side of the housing 2. In addition, the projector 4 may be or may not be a cylindrical acryl housing having a transmittance of 93% or less. Since glare to the housing will not occur when the transmittance is too high, the above-mentioned effect will not be achieved. For this reason, the transmittance may be set to a low level and glare to the housing may occur.

Specification of the projector 4 includes a focal distance (hereinafter, referred to as an allowable projection distance) and a projection ratio (hereinafter, referred to as an allowable projection angle).

The allowable projection distance is a projection distance required to correspond to the image size (a distance of an optical path from the projector 4 to the screen). When the actual projection distance is less than the allowable projection distance, the picture that is not focused cannot be projected clearly.

The allowable projection angle is an allowable value of an angle between the screen and an optical path of the picture projected to the screen. When the actual projection angle is less than the allowable projection angle, distortion of the image is increased, and in addition, the light intensity is different at both ends of the image and the image quality is degraded such as the image becoming blurred.

In consideration of these points, the projector 4 of the example has specification in which the allowable projection distance is relatively short and the allowable projection angle is relatively small, and further, the projector 4 and the screen (i.e., the screen 3) can be integrated to a compact size using the mirror 5.

Further, as in another example described below, the projector 4 may have specification in which the allowable projection distance is further shortened and the allowable projection angle is further reduced.

The column section 6 is a member standing up on the backmost section of the lower accommodating section 22, and stands up away from the housing 2 on the back surface side of the housing 2.

### Adjustment of Image Quality

For example, when the image of the character is projected by the projection device 1, what is particularly noticeable for a user is a face portion of the character that has a lot of variations in facial expressions. On the other hand, the character's feet change little, and the percentage that users care about is lower. In addition, around the face of the character, in addition to the eye, the nose and the mouth, it is preferable that a portion in which fine items such as accessories or the like are provided is displayed in fine solution. That is, the face area is required to be displayed in high resolution and the area other than the face is not expected to be displayed in high resolution compared to the face area.

In addition, in consideration of that the face area is required to be displayed in high resolution, when the light from the projector 4 is projected, for example, adjustment may be performed by the controller 71 described using FIG. 9 such that an image obtained by adjusting the resolution of the face area to high resolution and adjusting the resolution of the feet or the like far from the face to low resolution is displayed.

### Visual Effects

In this state, when the picture of the character or the like projected to the screen 3 is seen through the housing 2, the character or the like can be seen like an actual object more 3-dimensionally provided in the same space.

Reasons for exhibiting such visual effects will be described below.

As described above, in the projection device 1 of the example, the transparent board (the screen 3) is provided in the housing 2, and the picture is projected to the transparent film.

In the above-mentioned projection device 1, the user will see the character or the like displayed on the transparent film through the first window member 2a and the second window member 2b of the transparent housing 2.

In this example, the user will recognize a 3D environment, i.e., a vertical axis (height), a horizontal axis and a depth, in a space that is referred to the inside of the housing 2 restricted by being partitioned by the first window member 2a and the second window member 2b of the housing 2. For this reason, in particular, a visual effect (a 3D environment effect) of showing also the character itself 3-dimensionally (three dimensionally) is exhibited by recognizing a depth generated from a relation between the character or the like displaced in the space and the housing 2.

That is, the character or the like in a closed space and a partition of a depth side thereof will be recognized together by seeing the transparent second window member 2b behind the character or the like and, as a result, the character or the like is 3-dimensionally seem on the basis of a sense of depth between the character or the like in the same space and the transparent housing 2.

On the other hand, if the first window member 2a and the second window member 2b are removed and the picture of the character or the like projected to the transparent film is seen in a space opened with nothing around, while vertical and horizontal recognition in the surrounding space is strengthened, recognition of a depth is weakened.

Then, even when the picture of the character or the like projected to the transparent film is seen in such an open environment, since only presence of the film increases and a sense of depth cannot be easily felt, the 3-dimensional visual effect as described above cannot be exhibited.

In addition, when the transparent film is seen from the first window member 2a and the second window member 2b that are transparent, the transparent film becomes inconspicuous.

This is because that the left and right end portions of the screen 3 cannot be seen when the screen 3 is inscribed in the housing 2.

In addition, when a user looks rearward through a front material including a transparent material, the rear material cannot be easily seen.

If this is applied to the projection device 1 of the example, for example, when the housing 2 is seen from a front surface side, the screen 3 behind the housing 2 (the first window member 2a) cannot be easily recognized.

Then, when existence of the screen 3 having a flat surface shape is not recognized, the character or the like projected to the screen 3 is seen as if a 3-dimensional object that is not flat floats.

For this reason as well, presence of the housing 2 can make the picture such as the character or the like more 3-dimensional than the case in which the housing 2 is not provided.

In addition, the projection device 1 of the example is provided such that the pedestal 221 is provided on a lower side (at a lower end) of the screen 3 and the character's feet or the like is displayed to coincide with the lower end of the screen 3.

As a result, the picture looks as if the character or the like is standing on the pedestal 221 and as if the character or the like is a 3-dimensional object with a mass. Specific operation of controller

Next, a specific example of a control operation by the controller 71 will be described.

### Operation Related to Sound

When predetermined environment information including sound information is input, the controller 71 performs a control operation of outputting picture information and/or sound information linked to the environment information and related to a predetermined character or the like.

For example, when a user calls a name of the character or the like toward the microphone 704, the picture of the character or the like corresponding to the name can be displayed.

Specifically, the controller 71 converts sound input from the microphone 704 into a character string using a speech recognition program, extracts picture data of the character or the like previously linked to the character string from the storage device 75, and outputs the picture data from the projector 4. Accordingly, the picture of the character or the like output from the projector 4 is projected to the screen 3 via the mirror 5 (see FIG. 1).

For this reason, a user can call up a favorite character or the like when he/she likes it, and can display the character or the like in the transparent housing 2 in which the character or the like can be more 3-dimensionally seen.

In addition, when the user speaks to the character or the like, the character or the like can be operated as if the character or the like behaves according to the user's talk.

For example, when the sound of “Today's weather?” is input from the microphone 704 through the user's talk, the controller 71 converts the sound into a character string, extracts information related to today's weather (for example, “fine”) previously linked to the character string from the storage device 75, and outputs predetermined sound from the speaker. For example, the voice of the displayed character or the like can be output as “Today's weather is fine.”

In addition, when the sound of “I'm leaving now,” “I'm home” or “Good night” is input from the microphone 704 through the user's speaking, the controller 71 converts the sound into a character string, extracts sound data of “See you later,” “Welcome back” and “Good night” previously linked to the character string from the storage device 75 and outputs the sound from the speaker, and extracts a gesture picture of the character or the like previously linked to the character string from the storage device 75 and outputs the gesture picture from the projector 4. The picture of the character or the like output from the projector 4 is projected to the screen 3 via the mirror 5.

Accordingly, not only the character or the like can be simply 3-dimensionally displayed, but also an interactive function can be provided.

For this reason, a feeling as if the user is living with the character or the like in the same space can be provided to the user.

In addition, it is also possible to control the lighting on/off according to a sound input.

For example, when sound of “Turn off the light” or “Good night” is input from the microphone 704, the controller 71 extracts remote control information related to the lighting off previously linked to the character string and stored in the storage device 75 from the storage device 75, and transmits corresponding infrared information from the infrared LED 703.

Accordingly, indoor illumination can be turned off. In addition, similarly, the lighting can be turned on according to “Welcome back” or “Good morning.”

Further, a control operation obtained by combining such a sound input and human detection by the motion sensor 702 is also possible.

For example, when sound of “I'm leaving now” is input from the microphone 704 through the user's speaking, the controller 71 is shifted to a monitoring mode corresponding to a character string obtained according to the sound. Further, the controller 71 can also be shifted to a monitoring mode corresponding to “See you later” according to the character or the like.

The monitoring mode is a mode in a state in which the user does not exist in the designated space.

For this reason, the monitoring mode can be canceled when sound of “I'm home” can be input through the user's talk, and the character string obtained by the sound is detected. Further, the monitoring mode can also be canceled in response to “See you later” by the character or the like.

During the monitoring mode, for example, when a person is detected by the motion sensor 702, the controller 71 can determine that this is abnormal and can inform the user of this. Specifically, a predetermined alarm sound or warning message can be output from the speaker, and the predetermined message can be transmitted to a destination registered in advance via the communication device 76.

In addition, here, the controller 71 can photograph the indoor using the camera 722 and store the image in the storage device 75 or transmit the image to the destination registered in advance via the communication device 76.

Further, after a person is detected by the motion sensor 702 during the monitoring mode, it may be determined immediately that it is abnormal and notification is made, or it may be determined that it is abnormal and notification is made when the monitoring mode is not cancelled within a fixed time.

### Control Operation Related to Infrared LED

As a control operation using the infrared LED 703, the following operation can be performed.

Specifically, the controller 71 controls an operation of the corresponding instrument on the basis of behavior information linked to the time information when it is a rising time previously set by a timer program.

For example, when a timer program in which “lighting on” is performed upon rising (7:00) and “lighting off” is performed upon sleeping (23:00) is registered, the controller 71 extracts remote control information of “lighting on” from the storage device 75 and transmits the corresponding infrared information from the infrared LED 703 when it becomes 7:00, and extracts remote control information of “lighting off” from the storage device 75 and transmits the corresponding infrared information from the infrared LED 703 when it becomes 23:00.

As a result, a predetermined instrument can be automatically operated at a predetermined date and time.

In addition to this, it is possible to perform ON/OFF control of an air conditioner or the like according to a temperature and a humidity detected by a temperature/humidity sensor, or to perform ON/OFF control of a television according to a time zone.

### Control Operation Related to Camera 722

For example, it is possible to detect that a curtain is not open even though it is daytime, using the camera 722 and prompt the user to open the curtain.

Specifically, the time of sunrise is stored as calendar information in the storage device 75, and when the illuminance input from the camera 722 does not satisfy a predetermined illuminance even if the time passes, the controller 71 outputs sound data (“Open the curtain”) previously stored in the storage device 75 from the speaker.

### Control Operation Related to Noise Sensor

For example, the user can be warned that the television has been ON for a long time using the noise sensor 713.

Specifically, the controller 71 determines that the television is turned on based on a sound volume, a frequency and so on, of the sound input by the noise sensor 713 and starts counting from the time the determination is made, and extracts sound data (“Turn off the television”) previously stored in the storage device 75 and outputs the sound from the speaker when the time in this state exceeds a predetermined time.

Accordingly, while contributing to energy saving, it is possible to give the user a feeling as if the user is being warned by his/her partner.

### Control Operation Related to Vibration Sensor

It is possible to perform detection of an earthquake or a reporting operation thereof using the vibration sensor 712.

For example, in a state in which the motion sensor 702 has not detected presence of a person, it is determined that an earthquake occurred when a shake of a predetermined magnitude is detected by the vibration sensor 712, the controller 71 can output a predetermined alarm sound or warning message from the speaker, or transmit a predetermined message to a previously registered destination via the communication device 76.

On the other hand, in a state in which the motion sensor 702 has detected presence of a person, when a shake of a predetermined magnitude is detected by the vibration sensor 712, it is determined that the shake is caused by a human act by the user or the like, and notification is not performed. Further, in this example, a sound message (“Don't shake!”) can be output from the speaker.

As a result, an earthquake and a life vibration can be accurately discriminated, and each operation corresponding thereto can be performed.

### Control Operation Related to Temperature/Humidity Sensor

A predetermined sound output control corresponding to the temperature/humidity sensor can be performed.

For example, when a temperature detected by the temperature/humidity sensor is less than 10° C., the controller 71 can output sound of “It's cold today” from the speaker at a predetermined timing.

In addition, when a humidity detected by the temperature/humidity sensor is less than 40%, the controller can output sound of “It's dry! Be careful of cold.” from the speaker at a predetermined timing.

In addition to this, various input/output control operations become possible.

For example, it is possible to output sound of “Take your umbrella” on the basis of input information of a temperature/humidity or weather information, or display recommended clothes that correspond to a temperature/humidity, weather information, calendar information and so on, with respect to input of sound of “What am I going to wear?” from the user.

As described above, according to the projection device 1 of the example, it is possible to display the character or the like that is a display object in the same space more 3-dimensionally like an actual object in the same space.

In addition, the projection device 1 has a structure in which these instruments or parts are integrated to a compact size by adjusting a position or an angle of the projector 4 or the mirror 5 while the mirror 5 is provided.

In addition, the projection device 1 can make the character or the like displayed on the screen 3 clear according to a material of the screen 3.

In addition, in a so-called transmissive screen in the related art, while the projector installed in the rear is put into the user's field of view through the screen, the projector 4 does not enter the field of view by using the mirror 5.

In addition, it is possible to prevent realism of the character or the like from being damaged by preventing the user from recognizing glare of the user itself to the mirror 5 and a background of the user reflected in the mirror 5 via the mirror 5 according to a material or a structure of the mirror 5.

In addition, a clear image can be displayed by controlling the luminance uniformly during display.

In addition, since a wide range of the user's face can be imaged using the camera by providing the camera 722 away from the user, an image recognition percentage can be improved.

In addition, since the user's face can be photographed by the camera by causing the camera 722 to photograph a range in which the user's face is more likely to exist, an image recognition percentage can be improved.

In addition, in the projection device 1 of the example, the character or the like performs actions in response to the user's sound and various types of environment information.

Accordingly, it is possible to give the user a sense of being in the same space as the actual character or the like.

For example, it is possible to call a desired character or the like and to perform various output operations that seem to be living in the same space, including a conversation with the called character or the like.

In addition, these points are largely different from conventional home robots that consist of hardware having a fixed external form.

In other words, the conventional robots tend to bore the user because their morphology does not change, and when they are shared by a plurality of users, some users may not feel familiar and may find it difficult to perform communication.

On the other hand, according to the projection device 1 of the example, it can be provided as a digital communication robot corresponding to every user.

While the examples of the disclosure have been described based on the drawings and examples, it should be understood by those skilled in the art that various modifications or variations may be made based on the disclosure. Accordingly, such modifications and variations are included in the scope of the disclosure. By way of examples with no limitation, functions or the like included in each means, each step or the like, can be rearranged to not be logically contradictory, and it is possible to combine the pluralities of means, steps or the like, into one or divide them. In addition, the configurations shown in the examples may be combined as appropriate.

What is claimed is:

1. A projection device comprising:
a projector configured to project light;
a reflector configured to reflect light emitted from the projector;
a screen to which the light reflected by the reflector is projected, and which transmits at least some of the projected light; and
a housing in which the projector, the reflector and the screen are installed,
wherein the reflector is inclined with respect to the screen and installed in the housing.

2. The projection device according to claim 1, wherein the housing comprises a portion in which the projected light is scattered by the screen, and which transmits at least some of the light scattered by the screen.

3. The projection device according to claim 1, wherein the reflector has unevenness provided on at least a part of a reflecting surface of the reflector.

4. The projection device according to claim 1, wherein the reflector has first unevenness provided on a first portion of a reflecting surface of the reflector, and second unevenness provided on a second portion different from the first portion of the reflecting surface and larger than the first unevenness.

5. The projection device according to claim 3, wherein the reflector has the reflecting surface installed on a surface having the unevenness and configured to reflect light emitted from the projector.

6. The projection device according to claim 1, wherein the reflector reflects some of the light emitted from the projector and transmits some of the light emitted from the projector.

7. The projection device according to claim 6, wherein the reflector has a surface on which processing of minimizing reflection of the light is performed opposite to the surface configured to reflect the light emitted from the projector.

8. The projection device according to claim 1, wherein the reflector has a reflection coefficient that differs according to an angle of light entering the reflector.

9. The projection device according to claim 8, wherein the reflector has a reflection coefficient of light entering from an angle inclined by 45 degrees from a vertical line with respect to the reflecting surface of the reflector, which is larger than a reflection coefficient of light entering perpendicular to the reflecting surface of the reflector.

10. The projection device according to claim 8, wherein the projector comprises an image generator configured to generate an image projected to the screen, and
a controller configured to control the image generator is further provided to correct spots of luminance of the image projected to the screen according to the reflection coefficient of the reflector.

11. The projection device according to claim 1, wherein the screen comprises a scattering member configured to scatter the projected light.

12. The projection device according to claim 11, wherein the scattering member contains at least an inorganic material.

13. The projection device according to claim 1, further comprising a camera disposed in the housing.

14. The projection device according to claim 13, wherein at least a part of the camera is disposed between the projector and the screen.

15. The projection device according to claim 13, further comprising a detector installed outside the housing and configured to detect surroundings of the housing.

16. The projection device according to claim 15, wherein the camera is disposed at a position closer to the screen than the detector.

17. The projection device according to claim 13, wherein the projector performs projection related to a character or projection related to a person on the screen, and performs projection control related to the character and projection control related to the person on the basis of the image captured by the camera.

18. The projection device according to claim 1, wherein the projector performs projection related to a character or projection related to a person on the screen.
